(19) United States
(12) Patent Application Publication
(10) Pub. No.: US 2013/0016017 A1
(43) Pub. Date: Jan. 17, 2013

(54) CARD DEVICE

(71) Applicants: Koji AKITA, Kanagawa (JP); Seiichiro Horikawa, Kanagawa (JP); Hideo Kasami, Kanagawa (JP)

(72) Inventors: Koji AKITA, Kanagawa (JP); Seiichiro Horikawa, Kanagawa (JP); Hideo Kasami, Kanagawa (JP)

(73) Assignee: KABUSHIKI KAISHA TOSHIBA, Tokyo (JP)

(21) Appl. No.: 13/416,484

(22) Filed: Mar. 9, 2012

(30) Foreign Application Priority Data
Jul. 11, 2011 (JP) 2011-152911

(51) Int. Cl. H01Q 1/24

(52) U.S. Cl. 343/702

(57) ABSTRACT

According to an embodiment, a card device connected to a device includes a wireless communication unit configured to make wireless communication. The wireless communication unit includes an antenna configured to be arranged therein as being apart from at least one of side faces of the card device by a distance corresponding to not less than a wavelength of a wireless signal that is emitted from the wireless communication unit.

### CROSS-REFERENCE TO RELATED APPLICATION(S)

This application is based upon and claims the benefit of priority from Japanese Patent Application No. 2011-152911, filed on Jul. 11, 2011; the entire contents of which are incorporated herein by reference.

### FIELD

Embodiments described herein relate generally to a card device.

### BACKGROUND

A card device (hereinafter merely referred to as a card) having embedded therein a wireless communication unit has been known. Inserting such card into an electronic device provided with a card slot can allow the electronic device to have a wireless communication function.

Wireless signal emitted from the wireless communication unit is a desired signal for the other end of the communication, but it may become an interference signal i.e., an electromagnetic noise for the electronic device having the card inserted therein. Specifically, in such a card having embedded therein the wireless communication unit, the wireless signal emitted from the wireless communication unit might be electromagnetic noise for the electronic device having the card inserted therein.

### BRIEF DESCRIPTION OF THE DRAWINGS

FIG. 1 is a top view of a card according to a first embodiment;

FIG. 2 is a sectional view taken along a line A-A′;

FIG. 3 is a view illustrating the card inserted into a card slot;

FIG. 4 is a sectional view of the state illustrated in FIG. 3 viewed from a side of the card;

FIG. 5 is a view illustrating one example of a card having a shape different from that shown in FIG. 1;

FIG. 6 is a view illustrating the card inserted into a card slot;

FIG. 7 is a top view of a card according to a second embodiment; and

FIG. 8 is a sectional view taken along a line B-B′ in FIG. 7.

### DETAILED DESCRIPTION

According to an embodiment, a card device connected to a device includes a wireless communication unit configured to make wireless communication. The wireless communication unit includes an antenna configured to be arranged therein as being apart from at least one of side faces of the card device by a distance corresponding to not less than a wavelength of a wireless signal that is emitted from the wireless communication unit.

Embodiments of a card device will be described in detail below with reference to the attached drawings.

### First Embodiment

A card according to the first embodiment is a card-type device that is used as being connected to an electronic device such as a PC (personal computer), a cellular phone, and a digital camera. The card according to the present embodiment has a wireless communication function, and affords the wireless communication function to the electronic device to which the card is connected. An SD card or micro SD card is applicable for the card according to the embodiment. The card according to the present embodiment does not have to have a memory function, and only has the wireless communication function.

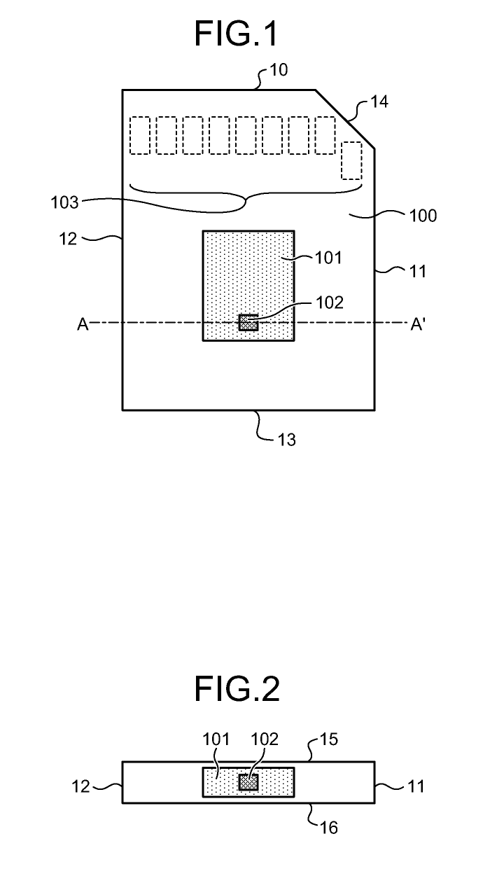

FIG. 1 is a top view illustrating one example of a card 100 according to the first embodiment. The card 100 according to the first embodiment includes a wireless communication unit 101 and input/output terminals 103.

The input/output terminals 103 are those used for electrically connecting the card to an electronic device (not illustrated in FIG. 1). FIG. 1 illustrates the example of the input/output terminals 103 of the card 100 that is an SD card having nine terminals. A dotted line indicates that the terminals are actually mounted on a backside of the card 100 in FIG. 1.

The wireless communication unit 101 makes wireless communication with an external device. The external device includes an electronic device to which the card 100 is connected, and a device other than the electronic device. The wireless communication unit 101 is provided with an antenna 102 that is embedded therein as being apart from at least one of side faces of the card 100 by a distance corresponding to not less than a wavelength of a wireless signal of the wireless communication unit 101.

The card 100 illustrated in FIG. 1 has a shape of rectangular solid, a part of which is cut out. Specifically, the card 100 has side faces 10, 11, 12 and 13, and a side face 14 corresponding to the cutout section. FIG. 2 is a sectional view taken along a line A-A′ in FIG. 1. As illustrated in FIG. 2, the card 100 has a top face 15 and a bottom face 16.

The card 100 thus configured can efficiently reduce an electromagnetic noise, emitted from the wireless communication unit 101, when the card 100 is used as being inserted into a card slot of the electronic device.

The reduction in the electromagnetic noise will be described in detail below. The inserting direction of the card 100 illustrated in FIG. 1 to the card slot is generally determined beforehand. For example, the inserting direction may be indicated by an arrow, which indicates the inserting direction, written on the card 100. There may be a case in which the card 100 has the input/output terminals 103 as illustrated in FIG. 1, which allows a user to know that the card is to be inserted from the input/output terminals 103.

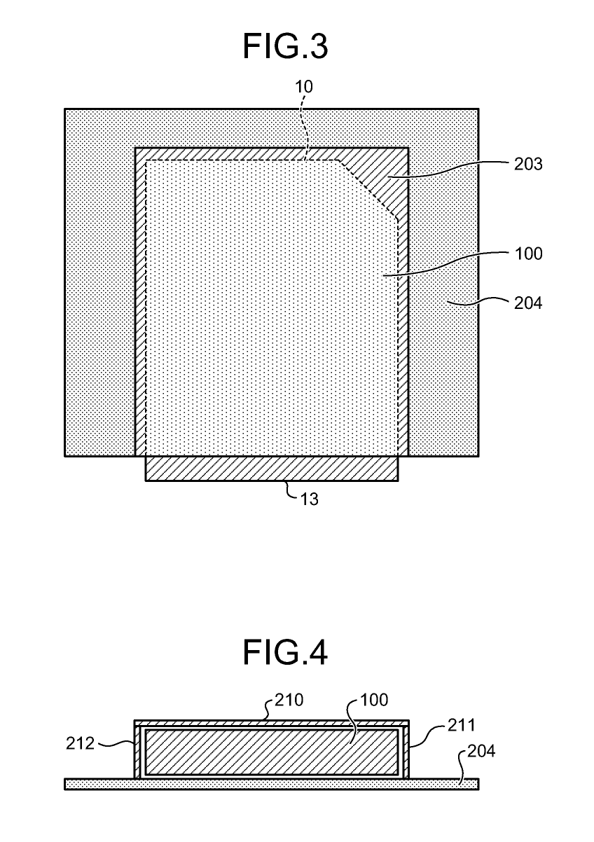

FIG. 3 is a view illustrating the card 100 inserted in the card slot. FIG. 3 illustrates that the card 100 is inserted into a card slot 203 mounted on a substrate 204 of the electronic device.

As illustrated in FIG. 3, when the card 100 is inserted into the card slot 203, the card slot 203 encloses the periphery of the card 100. Even though electromagnetic noise is emitted from inside of the card 100, the electromagnetic noise can be reduced to some extent by the card slot 203 and the substrate 204, since the card 100 is enclosed by the card slot 203. In other words, the card slot 203 and the substrate 204 serve as a shield wall to shield the electromagnetic noise emitted from the inside of the card 100 to some extent.

It has generally been known that, the farther the shield wall is provided from the generation source of the electromagnetic noise, the more the shield effect enhances, i.e., the more the noise-reducing amount becomes. On the contrary, when the distance between the shield wall and the generation source of the electromagnetic noise is small, the shield effect is reduced. This is because, when the shield wall becomes close to the generation source of the electromagnetic noise, the shield wall falls within a near field to the generation source, and hence, electromagnetic field is induced to the shield wall. It has generally been known that the shield effect can efficiently be enhanced, when the shield wall and the generation source of the electromagnetic noise are provided apart from each other by the distance nearly corresponding to the wavelength of the wireless signal, for example.

FIG. 4 is a sectional view illustrating the state in FIG. 3 viewed from the side face 13 of the card 100. Since the card 100 is thin, it is relatively difficult to secure a distance between any portions in the card 100 and a top face 210 of the card slot 203 or the substrate 204. On the other hand, it is relatively easy to secure a distance from side faces 211 and 212 of the card slot 203 opposing the side faces of the card 100.

In view of this, in the first embodiment, the antenna 102 is provided as being apart from at least one of the side faces of the card 100 by the distance corresponding to not less than the wavelength of the wireless signal. This structure can make the distance not less than the wavelength from the side face of the card slot 203, when the card 100 is inserted into the card slot 203. Thus, the shield effect can efficiently be enhanced.

A millimeter wave may be used as the wireless signal of the wireless communication unit 101. The wavelength becomes short by use of the millimeter wave. Therefore, the distance from the side face of the card 100 can easily be secured.

The distance from the side face of the card 100 may be defined as the distance from the outer surface of the card 100. With this, the distance can be specified with the face, which is closer to the face of the card slot 203, being defined as a reference.

The condition of “not less than the wavelength of the wireless signal” for the distance may be replaced by a condition of “not less than a distance to a boundary of a near field”, for example. The distance to the boundary of the near field can be represented as λ/(2π, wherein the wavelength is defined as λ. In a case when the size of the antenna 102 is large, the distance to the boundary of the near field can be represented as 2D̂s/λ (D is the size of the antenna). The size of the antenna 102 means the distance between two points, the distance being the longest in the antenna 102. The shield effect can efficiently be enhanced by setting the distance from the side face of the card 100 to be not less than the distance to the boundary of the near field.

As illustrated in FIGS. 3 and 4, the card slot 203 has at least one open face into which the card 100 is inserted. The open surface generally faces outward of the electronic device for the function of receiving the card 100 inserted. The wireless signal emitted toward outside of the electronic device is difficult to become the electromagnetic noise to the electronic device having the card 100 inserted therein. On the other hand, the wireless signal emitted toward the faces other than the open face is easy to become the electromagnetic noise to the electronic device, since this wireless signal is emitted toward inside of the electronic device.

In consideration of this situation, the antenna 102 may be configured such that the antenna 102 is embedded therein as being apart from the face, except for the face (side face 13) opposing one face (the side face 10) in the inserting direction of the card 100 out of the side faces of the card 100, by the distance corresponding to not less than the wavelength of the wireless signal. In other words, the antenna 102 may be arranged as being apart from the faces other than the face (side face 13) in the direction reverse to the inserting direction of the card 100 by the distance corresponding to not less than the wavelength. With this structure, the shield effect can be enhanced better.

The input/output terminals 103 are generally arranged in the inserting direction of the card 100 in most cases. Therefore, the face opposing the input/output terminals 103 is frequently defined as the open face of the card slot 203. In view of this, the antenna 102 may be embedded as being apart from the faces, except for the face (side face 13) opposing the face (side face 10) that is the closest to the input/output terminals 103 out of the side faces of the card 100, by the distance corresponding to not less than the wavelength of the wireless signal. With this structure, the shield effect can be enhanced better.

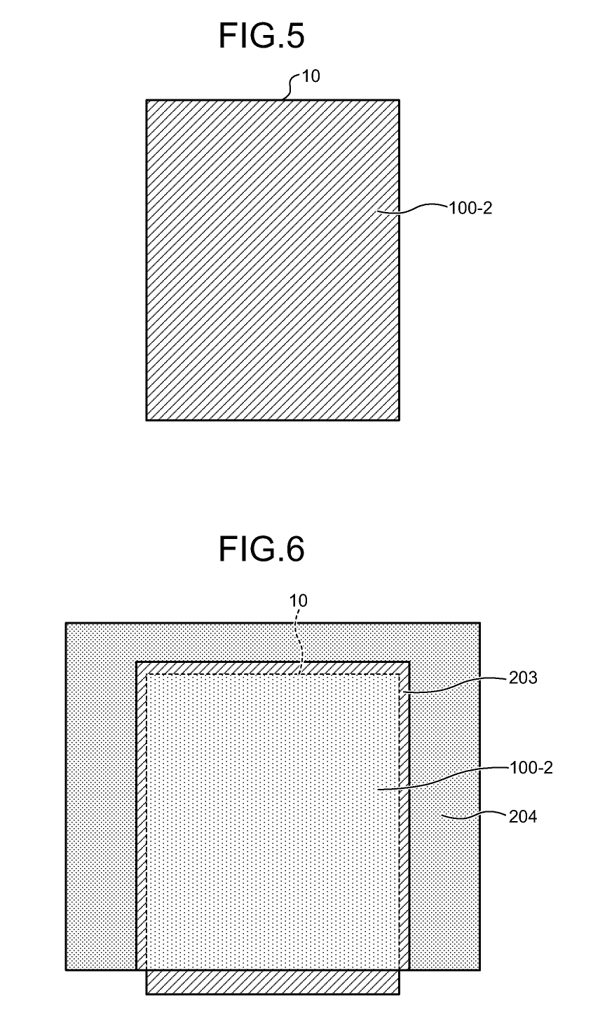

FIG. 5 is a view illustrating one example of a card 100-2 having a shape different from that of the card shown in FIG. 1. FIG. 6 is a view illustrating the card 100-2 inserted into the card slot 203. As illustrated in FIGS. 5 and 6, the card 100-2 may have a shape of a rectangular solid, i.e., a rectangular shape viewed from top.

As described above, the card device according to the first embodiment can efficiently reduce the electromagnetic noise emitted from the wireless communication unit. If the millimeter wave is used as the wireless signal, the distance corresponding to the wavelength can easily be secured, since the millimeter wave has a short wavelength.

### Second Embodiment

When components (e.g., memory, memory controller, and other electronic components) other than the wireless communication unit 101 are embedded in the card 100, a space for arranging these components is desirably secured. In the second embodiment, the wireless communication unit 101 is arranged in order to secure the space for the components.

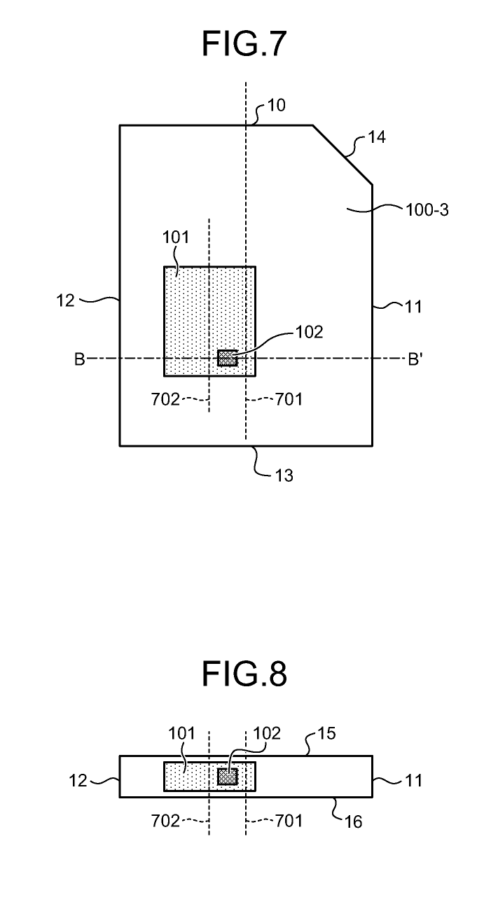

FIG. 7 is a top view of a card 100-3 according to the second embodiment. FIG. 8 is a sectional view taken along a line B-B′ in FIG. 7. The card 100-3 according to the second embodiment is different from the first embodiment in the arrangement of the wireless communication unit 101 in the card 100-3 and the arrangement of the antenna 102 in the wireless communication unit 101.

Specifically, in the second embodiment, the wireless communication unit 101 is arranged as being shifted from a center line 701 of the card 100-3 toward the side face 12. The antenna 102 is arranged as being shifted from a center line 702 of the wireless communication unit 101 toward the direction reverse to the direction (toward the side face 12) of shifting the wireless communication unit 101.

With this arrangement, a large space is easy to be secured inside the card 100-3, whereby the components other than the wireless communication unit 101 can easily be embedded. Even when the wireless communication unit 101 is arranged close to the end of the card 100-3, the distance between the antenna 102 and the side face of the card 100-3 can easily be secured.

In this case, the antenna 102 may be arranged apart from any one of the side faces of the wireless communication unit 101 by the distance corresponding to not less than the wavelength of the wireless signal. With this structure, the wireless communication unit 101 can be arranged with this side face being proximate to the side face of the card 100-3, whereby the space can more efficiently be secured.

As described above, the second embodiment not only enhances the shield effect but also effectively utilizes the space in the card.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A card device capable to be connected to a device, comprising
a wireless communication unit configured to perform wireless communication, wherein
the wireless communication unit includes an antenna arranged therein as being apart from at least one of side faces of the card device by a distance corresponding to not less than a wavelength of a wireless signal that is emitted from the wireless communication unit.

2. The card device according to claim 1, wherein
the antenna is apart from side faces, other than a face in the direction reverse to an inserting direction of the card device out of the side faces, by the distance corresponding to not less than the wavelength.

3. The card device according to claim 2, wherein
the wireless communication unit is arranged close to one of two side faces in the direction orthogonal to the inserting direction of the card device, and
the antenna is arranged toward the direction reverse to the direction of the one face in the wireless communication unit.

4. The card device according to claim 1, wherein
the antenna is provided apart from respective faces out of the side faces, other than a face opposing one face that is the closest to a terminal for connecting to the device, by the distance corresponding to not less than the wavelength.

5. The card device according to claim 4, wherein
the wireless communication unit is arranged close to one of two side faces that are adjacent to the one face closest to the terminal for connecting to the device, and
the antenna is arranged toward a direction reverse to the direction of the one face in the wireless communication unit.

6. The card device according to claim 1, wherein
the wireless signal is a millimeter-wave signal.
